(19) United States
(12) Patent Application Publication
(10) Pub. No.: US 2003/0067421 A1
(43) Pub. Date: Apr. 10, 2003

(54) Variable focusing projection system

(76) Inventor: Alan Sullivan, White Plains, NY (US)

Correspondence Address: Abraham Kasdan, Esq., Amster, Rothstein & Ebenstein, 90 Park Avenue, New York, NY, 10016, US

(21) Appl. No.: 10/268,731

(22) Filed: Oct. 9, 2002

Related U.S. Application Data
(60) Provisional application No. 60/328,515, filed on Oct. 10, 2001.

(51) Int. Cl. G09G 5/00

(52) U.S. Cl. 345/6

(57) ABSTRACT

A variable focusing projection system for controllably focusing image slices of an object onto respective optical elements of a volumetric display device, such as a multiple optical element device, by changing the effective object distance of the object and thereby adjusting the image distance. A variable focusing projection system comprises a projection lens and an object distance modifier. The object distance modifier is located between the object and the projection lens and has an index of refraction greater than 1 and variable thickness. The system controllably positions a predetermined thickness of the object distance modifier in the optical path. The object distance modifier may comprise a disk made of a transparent material with an azimuthally varying thickness. The disk may be controllably rotated to position the predetermined thickness in the optical path to generate a desired image distance.

### CROSS-REFERENCE TO RELATED APPLICATION

This patent application claims the benefit of U.S. Provisional Application No. 60/328,515, filed Oct. 10, 2001.

### BACKGROUND OF THE INVENTION

The present invention relates to optical projection systems that display three-dimensional images. More particularly, this invention relates to a variable focusing projection system that can provide a focused image over a range of image distances which span the extent of a multiple optical element device.

In the case of a typical image projector, such as a movie projector, projection television, or slide projector, a magnified image of a fixed image source is projected onto a single, fixed display surface. The image may originate from a wide range of sources. It may be the image of a real object (e.g., a slide in slide projector or a frame of a motion picture film), or it may originate from a reflective or transmissive spatial light modulator (SLM) forming video images from a digital data source. In such typical image projector, the projection lens is only required to produce a focused image of the image source at one position, i.e., the screen location.

However, in the case of a multi-planar volumetric display system, a set of image slices from an image source whose distance is fixed with respect to a projection lens must be projected and magnified onto a plurality of display surfaces that are typically arranged in an array at different distances from the projection lens. In this situation, the depth of field of the optical system may not be sufficient to provide an image that is properly focused on each of the plurality of display surfaces. Thus there is a need for a variable focusing projection system in which the focus can be rapidly adjusted so that each image that forms a volumetric display is brought to proper focus on its corresponding display surface in the volumetric display.

This need may be better understood by reference to FIG. 1, which illustrates the overall components of a multi-planar volumetric display system described in U.S. Pat. No. 6,100,862 and U.S. Pat. No. 6,377,229 to Alan Sullivan, the contents of which are incorporated herein by reference.

Referring to FIG. 1, the multi-planar volumetric display system 10 includes an interface 14 for receiving 3D graphics data from a graphics data source 16, such as a computer which may be incorporated into the system 10, or which may be operatively connected to the system 10 through communications channels from, for example, a remote location and connected over conventional telecommunications links or over any network such as the Internet. The interface 14 may be, for example, a PCI bus, or an accelerated graphics port (AGP) interface available from INTEL of Santa Clara, Calif.

The interface 14 passes the 3D graphics data to a multi-planar volumetric display (MVD) controller 18, which includes a large high speed image buffer. The three-dimensional image to be viewed as a volumetric 3D image is converted by the MVD controller 18 into a series of two-dimensional image slices at varying depths through the 3D image. The frame data corresponding to the image slices are then rapidly output from the high speed image buffer of the MVD controller 18 to an image projector 20.

The image projector 20 has associated optics 22 for projecting the two-dimensional slices 24-30 of the 3D image at a high frame rate and in a time-sequential manner to a multiple optical element (MOE) device 32 to generate a volumetric three-dimensional image 34 which appears to the viewer 12 to be present in the space of the MOE device 32. To form the volumetric three-dimensional image 34, the MOE device 32 includes a plurality of optical elements 36-42 which, under the control of the MVD controller 18, selectively receive and display each of the image slices 24-30 as two-dimensional images 44-50, with one optical element receiving and displaying a respective slice during each frame rate cycle. The number of depth slices generated by the MVD controller 18 is equal to the number of optical elements 36-42, that is, each optical element represents a unit of depth resolution of the volumetric 3D image 34 to be generated and displayed.

The optical elements 36-42 may be liquid crystal displays composed of, for example, nematic, ferroelectric, or cholesteric materials, or other polymer stabilized materials, such as cholesteric textures, that are capable of being electronically switched rapidly, for example, by an MOE device driver of the MVD controller 18, between a clear, highly transparent state and an opaque, highly scattering state. When in operation, a single liquid crystal element is controlled to have an opaque light-scattering state to receive and display the respective one of the set of images from the image projector; and the remaining liquid crystal elements are controlled to be substantially transparent to allow the viewing of the display image on the opaque liquid crystal element.

The optical elements 36-42 may be planar and rectangular, or alternatively may be curved and/or of any shape, such as cylindrical. For example, cylindrical LCD displays may be fabricated by difference techniques such as extrusion, and may be nested within each other. The spacing distance between the optical elements 36-42 may be constant, or in alternative embodiments may be variable such that the depth of the MOE device 32 may be greatly increased without increasing the number of optical elements 36-42. For example, since the eyes of the viewer 12 lose depth sensitivity with increased viewing distance, the optical elements positioned further from the viewer 12 may be spaced further apart. Logarithmic spacing may be implemented, in which the spacing between the optical elements 36-42 increased linearly with the distance from the viewer 12.

The overall display of each of the slices 24-30 by the optical elements 36-42 of the MOE device 32, as a set of displayed images, occurs at a sufficiently high frame rate, such as rates greater than about 35 Hz so that the human viewer 12 perceives a continuous volumetric 3D image 34, viewed directly and without a stereographic headset, and instead of the individual two-dimensional images 44-50. Accordingly, in the illustration of FIG. 1, if the images 44-50 are cross-sections of a sphere, the 3D image 34 thus generated would appear to the viewer 12 as a sphere positioned in the midst of the optical elements 36-42 forming the MOE device 32.

The maximum resolution and color depth of the three-dimensional image 34 generated by the MVD system 10 is directly determined by the resolution and color depth of the high frame rate image projector 20; and as explained, the role of the MOE device 32 is to convert the series of two-dimensional images from the image projector 20 into an image that appears to viewer 12 to occupy a volume of space.

The image projector 20 may include an arc lamp light source with a short arc. The light from the lamp is separated into red, green and blue components by color separation optics, and is used to illuminate three separate spatial light modulators (“SLMs”). After modulation by the SLMs, the three color channels are recombined into a single beam and projected from the optics 22, such as a focusing lens, into the MOE device, 32 such that each respective two-dimensional image formed by the image slices 24-30 is displayed on a respective one of the optical elements 36-42. The image projector 20 may use a high power solid state lasers instead of an arc lamp and color separation optics. Laser light sources have a number of advantages, including, increased efficiency, a highly directional beam, and single wavelength operation. Additionally, laser light sources produce highly saturated, bright colors.

In the prior art multi-planar volumetric display system of FIG. 1, the optics 22 of the projection lens is set to a fixed focus such that the inherent depth of focus is capable of producing an adequately resolved image over some range of image distances. As known in the art, the depth of focus is a function of the f-number of the optical projection system. For a simple lens, the f-number is the focal length of the lens divided by the effective diameter of the lens (or linear aperture). Thus, the depth of focus increases with increasing f-number. As a consequence, a multi-planar volumetric display system as shown in FIG. 1 requires an optical projection system having a relatively high f-number in order to provide a sufficiently large depth of focus to span the entire extent of the MOE device 32 along the optical axis. However, the amount of light that an optical system can collect from available high brightness light sources decreases with increasing f-number and this consequently limits the brightness of the image that can be obtained from a multi-planar volumetric display system having the exemplary arrangement shown in FIG. 1.

Hence, in prior art multi-planar volumetric display systems, there is an inherent design tradeoff that is accommodated between the need for a sufficient depth of focus to cover the entire MOE device 32 within the resolution requirements designed for the display and the desire to project high amounts of light for high image brightness.

For the foregoing reasons, there is a need for a rapidly adjustable variable focusing projection system that can provide a focused image over a range of image distances which span the extent of the multiple optical element device, thereby making it possible to employ relatively low f-number optics and high brightness light sources to produce bright images.

### SUMMARY

The present invention is directed to a rapidly adjustable variable focusing projection system that satisfies this need. An image projector of an optical projection system for projecting and focusing a plurality of image slices generated by an image source onto a corresponding plurality of optical elements located at different distances from the image projector to generate a volumetric three-dimensional image comprises a projection lens, an object distance modifier having an index of refraction greater than 1 and variable thickness and means for controllably positioning a predetermined thickness of the object distance modifier in the optical path between the image source and the projection lens to focus each image slices onto its corresponding optical element. The object distance modifier permits controllable adjustment of the image distance by changing the effective distance of the image source from the projection lens so that the adjusted image is focused onto a desired location within a volumetric display device such as a multiple optical element device.

The object distance modifier may comprise a disk having an azimuthally varying thickness. The values of the thickness and the index of refraction are selected to result in a desired amount of shift in the effective object distance so that a desired image distance is obtained. The disk may have a continuously varying thickness profile, such as a sinusoidal or triangular profile, or a discontinuously varying thickness profile, such as a “saw-tooth” or “stair-step” profile.

The object distance modifier may be mounted on a rotation device, such as motor, for rotating the object distance modifier at its center to position the predetermined thickness along the optical path of the projection system so as to obtain the desired image distance. The rotation axis of the disk, in this case, may be parallel to the optical axis of the projection system. This configuration would be particularly useful for incorporation in a multi-planar volumetric display system. By rotating the disk of azimuthally varying thickness at a predetermined rotation rate that is synchronized to the frame rate generated by a MVD controller 18 (FIG. 1), image slices produced by the image source can be projected and rapidly focused onto their corresponding optical elements 36-42 of the multiple optical element device 32 to generate a volumetric three-dimensional image. Variable focusing projection on the multiple optical element device 32 may be controlled by selecting a suitable disk material, disk size, thickness range, thickness profile and rotation rate.

### BRIEF DESCRIPTION OF THE DRAWINGS

Various objects and advantages of the invention will be apparent upon consideration of the following detailed description, taken in conjunction with the accompanying drawings, which are not drawn to scale, but are provided to illustrate various features of the inventive embodiments. These drawings, in which like reference numbers refer to like parts throughout, illustrate the following:

FIG. 1 illustrates a prior art multi-planar volumetric display system;

FIG. 2 is a diagram for illustrating the principle of an embodiment of the present invention;

FIG. 3 illustrates an embodiment showing the overall invention;

FIG. 4A is a perspective view of one embodiment of an object distance modifier in accordance with the present invention;

FIG. 4B illustrates a thickness profile near the edge of the object distance modifier of FIG. 4A as a function of azimuthal angle;

FIG. 5A is a perspective view of another embodiment of an object distance modifier in accordance with the invention;

FIG. 5B illustrates a thickness profile near the edge of the object distance modifier of FIG. 5A as a function of azimuthal angle;

FIG. 6A is a perspective view of still another embodiment of an object distance modifier in accordance with the invention;

FIG. 6B illustrates a thickness profile near the edge of the object distance modifier of FIG. 6A as a function of azimuthal angle;

FIG. 7A is a perspective view of yet another embodiment of an object distance modifier in accordance with the invention; and

FIG. 7B illustrates a thickness profile near the edge of the object distance modifier of FIG. 7A as a function of azimuthal angle.

### DETAILED DESCRIPTION OF THE PREFERRED EMBODIMENTS

By way of background and as is well known in the field of optics, the position of an image generated by an optical assembly is determined by the position of the object with respect to the optical assembly. (As used herein, the term “object” is intended to have its usual connotation in the field of optics and may refer to any object or image source in whatever form that is the source or “object” acted upon by an optical system to form an image.) The image may be projected onto a display surface by collecting light transmitted or reflected from the object or image source using a projection lens.

As is well known in the field of optics, in the so-called “thin lens” approximation, and in the case where both the object and the image are in located in air (having an index of refraction n=1), the relationship between object distance and image distance can be simply described as follows:

$$\frac{1}{f} = \frac{1}{o} + \frac{1}{i}$$

where f is the focal length of the lens, o is the distance of the object from the lens (i.e., the object distance) and i is the distance of the focused image from the lens (i.e., the image distance). So as to avoid any confusion, note that the focal length f is different from the f-number defined earlier (i.e., the focal length of the lens divided by the effective diameter of the lens). As evident, the image distance is determined by the object distance and, therefore, may be changed by changing the object distance.

Manipulating or controlling the object distance may be accomplished in a variety of ways. Obviously, changing the object distance may be accomplished by mechanically altering the actual object distance (i.e., the distance between the object and the lens). This method, however, may not be suitable for systems in which the image distances must change rapidly, such as a multi-planar volumetric display system which must respond to a high frame rate image projector.

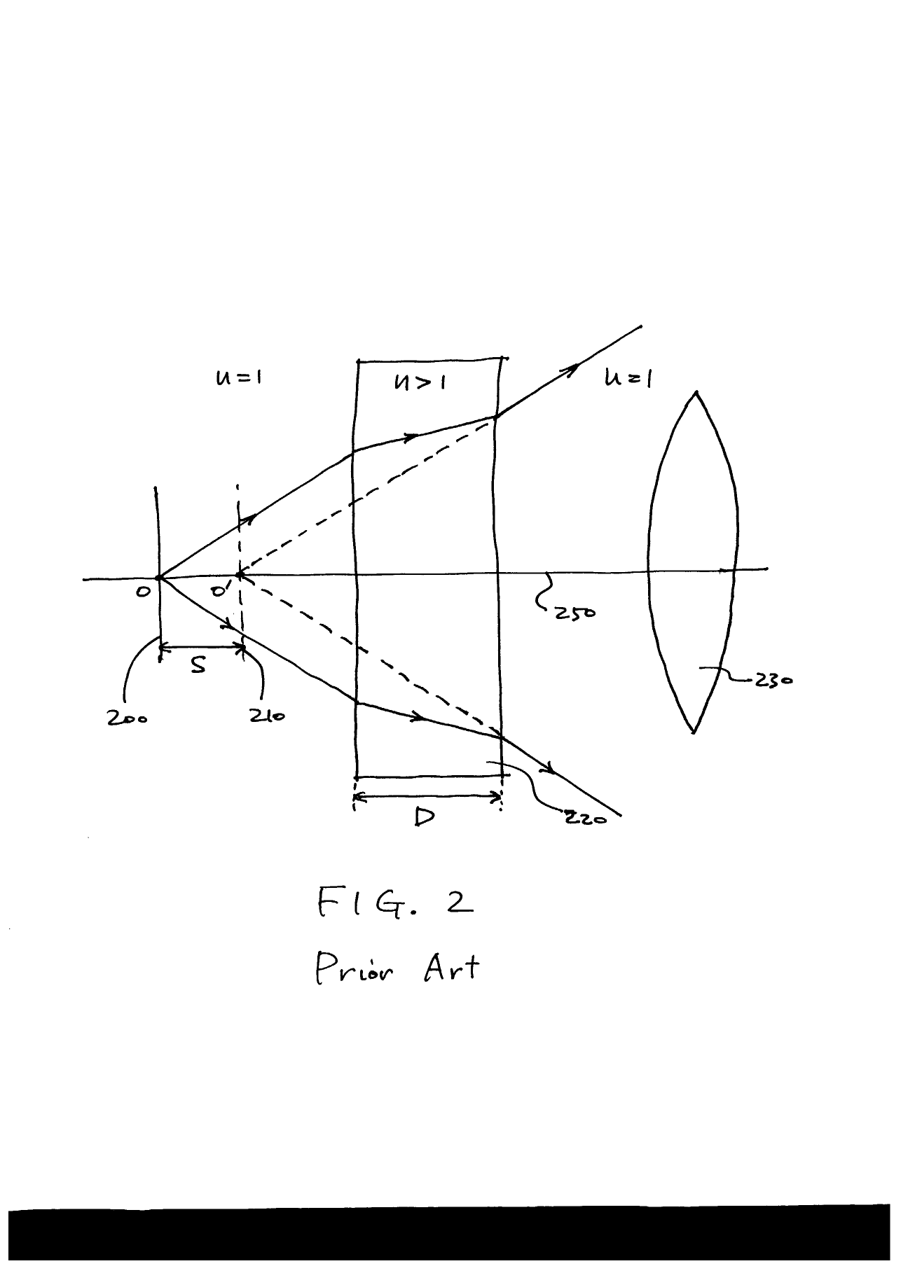

Thus, in a preferred embodiment of the invention, the image distance in a projection system is manipulated or controlled by changing the effective object distance, while keeping the object or image source fixed with respect to the projection lens. Specifically, as shown in FIG. 2, the effective object distance in an optical assembly may be changed, without changing the actual object distance, by inserting between the object located at a plane 200 and a lens 230 a transparent material 220 having an index of refraction n greater than 1.

The effect of inserting such transparent material 220 is to cause the object O, located at the plane 200, to appear to the lens 230 as if it is an object O′, located at a closer effective object distance to the lens (i.e., at the effective object plane 210). As explained below, the shift in the effective object distance depends on the index of refraction of the transparent material and the thickness D of the transparent material along the optic axis through which rays from the object must pass to reach the projection lens 230.

Specifically, if a transparent plate 220 having parallel surfaces and made of a material having a refractive index n>1, such as glass, is positioned as shown in FIG. 2, the shift S in the effective object distance from the actual distance between the object 200 and the lens 230 will be a function of the thickness of the material D and the refractive index of the material 220. Assuming paraxial rays, the shift S in object distance will be approximately:

$$\frac{n - 1}{n} D$$

where n is the refractive index of the material and D is the physical thickness of the transparent plate 220.

Accordingly, the effective object distance of object O′ from the lens 230 may be changed from the actual object distance of object O, by placing a transparent material having n>1 between the object O and the lens, without physically moving the object O relative to the lens. By controlling the change in the effective object distance, one can correspondingly effect controlled changes in the image distance and thereby dynamically focus images onto any location within the volume of a volumetric display device.

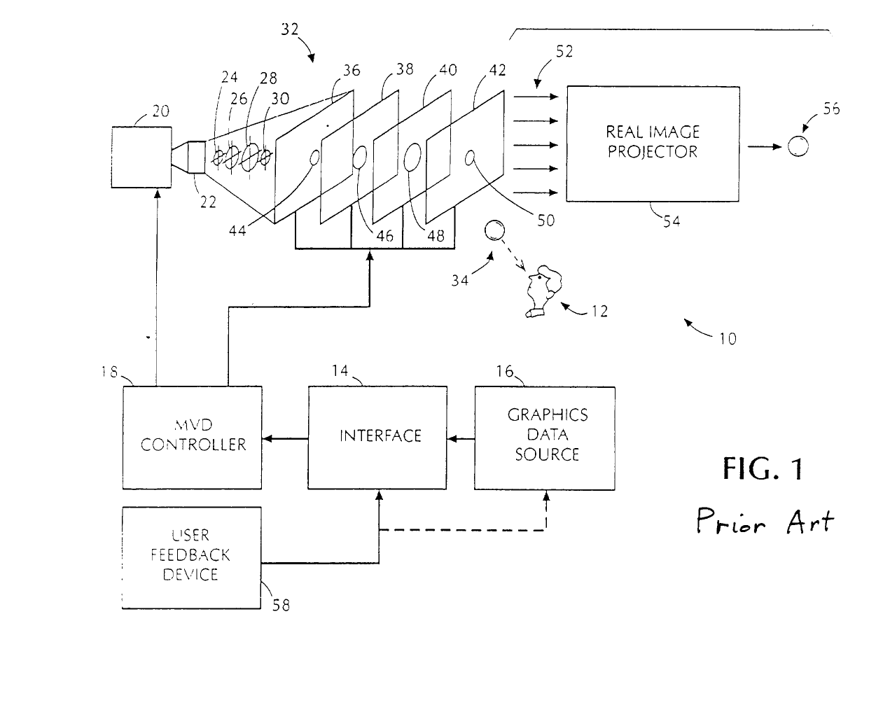

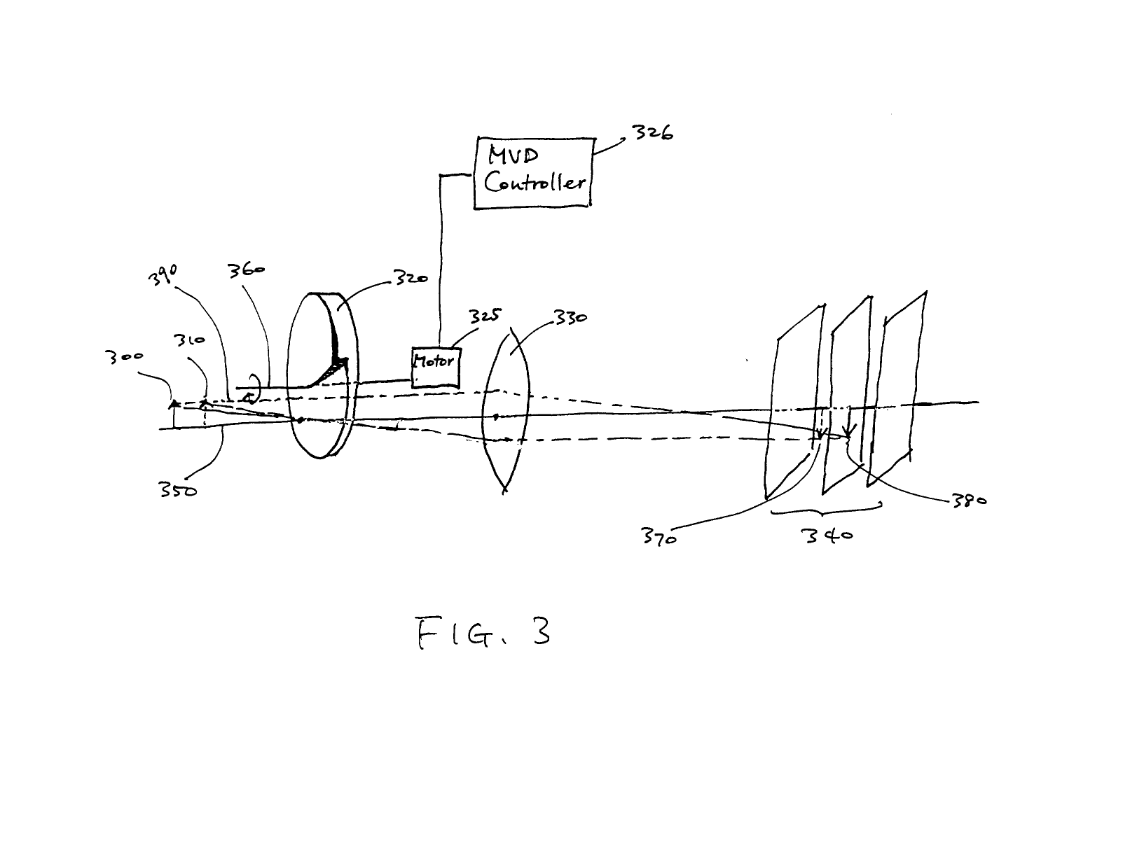

A preferred embodiment of the present invention incorporating the principle described above is shown in FIG. 3. FIG. 3 includes an object 300, an object distance modifier 320 made of a transparent material with index of refraction n>1, a lens 330 and a plurality of receiving surfaces 340 such as optical elements 36-42 as in a multiple optical element device 32 of FIG. 1. The object 300 may be any suitable object or image source. The lens 330 may be any suitable lens or assembly of lenses for magnifying and projecting an image. For example, the lens 330 may be an 100 mm focal length projection lens. The receiving surfaces 340 may be any suitable diffusing surface, such as, for example, one of the liquid crystal elements in a multiple optical element device 32, a lenticular diffuser, a holographic diffuser, or any other suitable diffusing surface, such as, for example, a surface constructed of vellum.

As explained above, the object distance modifier 320 maybe constructed of any suitable material with a desired index of refraction, depending on the application. In a preferred embodiment, the object distance modifier is constructed of BK7 glass. However, any sufficiently rigid and transparent material, such as plastic or other types of glass, may also be used.

The object distance modifier 320 can correspondingly adjust the image distance by changing the effective object distance in a controlled manner. In one embodiment, object distance modifier 320 may be a glass disk 320 having a varying thickness that is rotated about an axis 360 so as to controllably change the thickness of the portion of the disk in the optical path between the object 300 and the lens 330. For example, the thickness of the object distance modifier may range from 0.5 mm to 1.5 mm, or any other suitable range, depending on the application.

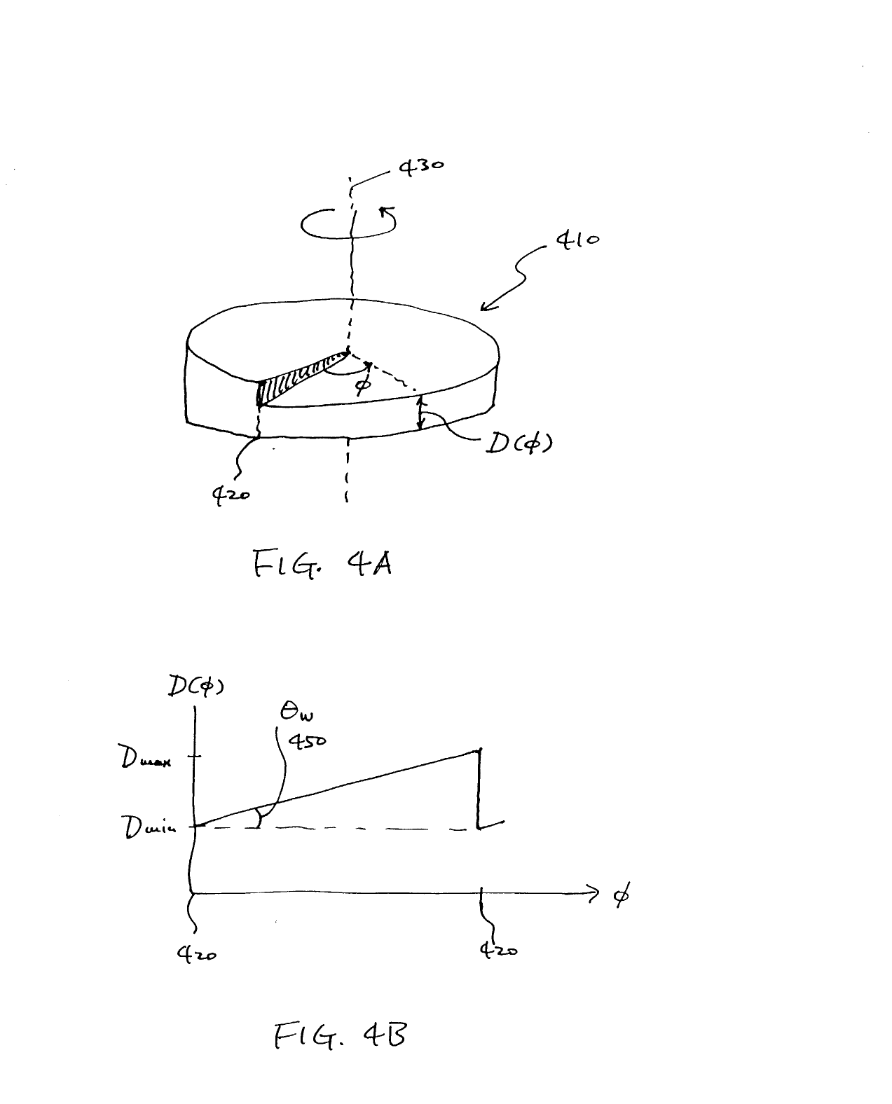

An object distance modifier 410 in the form of a disk with varying thickness in accordance with one embodiment of the invention is shown in FIG. 4A. The object distance modifier 410 has a continuously varying thickness except for one discrete jump at 420. The object distance modifier 410 may be mounted at its center to a rotation device 325 (for example, a motor), which may be synchronized to the frame rate generated by the MVD controller 326 (also 18 of FIG. 1). The object distance modifier 410 is placed between the object 300 and the lens 330 with its rotation axis 430 parallel to, but displaced from, the optical axis 350, as generally shown in FIG. 3, with the optical axis 350 passing through a portion of the disk. As the object distance modifier 410 rotates, the effective object distance (and correspondingly the image distance) will change. For example, if the object is located between f and 2f, then the image will be located beyond 2f and will be magnified. When the object distance modifier 410 is at its thickest position 420, the effective object distance will be closest to the lens and therefore the corresponding image will be focused at its longest image distance. As the object distance modifier 410 rotates so that rays 390 from the object 300 traverse regions of decreasing thickness of the object distance modifier 410, the effective object plane 310 will move closer to the object plane 300 and correspondingly, the image distance will decrease.

As should now be evident, by controlling the cross sectional shape of the image distance modifier 410, as well as the rotational speed thereof in synchronization with the MVD controller 18 of FIG. 1, it is possible to focus image slices originating on the spatial light modulator of the image projector 20 so that they can be successively focused onto optical elements 36-42 of the MOE device 32.

To illustrate the advantages of the objection distance modifier 410, let us assume that the lens 330 is an ideal 100 mm focal length projection lens, and that the object distance modifier 410 is made of BK7 glass (n=1.5) with a thickness D varying from Dₘᵢₙ=0.5 mm to Dₘₐₓ=1.5 mm as the azimuthal angle φ varies from 0° to 360° (see FIG. 4B). With the object distance modifier 410 at its minimum thickness (Dₘᵢₙ=0.5 mm) and separated from the object 300 by 52.0 mm and from the lens 330 by 52.59 mm, an image will be focused at a distance of 1886.23 mm. Rotation of the disk to its median thickness of 1.0 mm increases the image distance to 1998.71 mm. Rotation of the disk to its maximum thickness (Dₘₐₓ=1.5 mm) further increases the image distance to 2126.24 mm. Thus, a shift of 240 mm in the image distance can be generated by a variation of merely 1 mm in glass thickness.

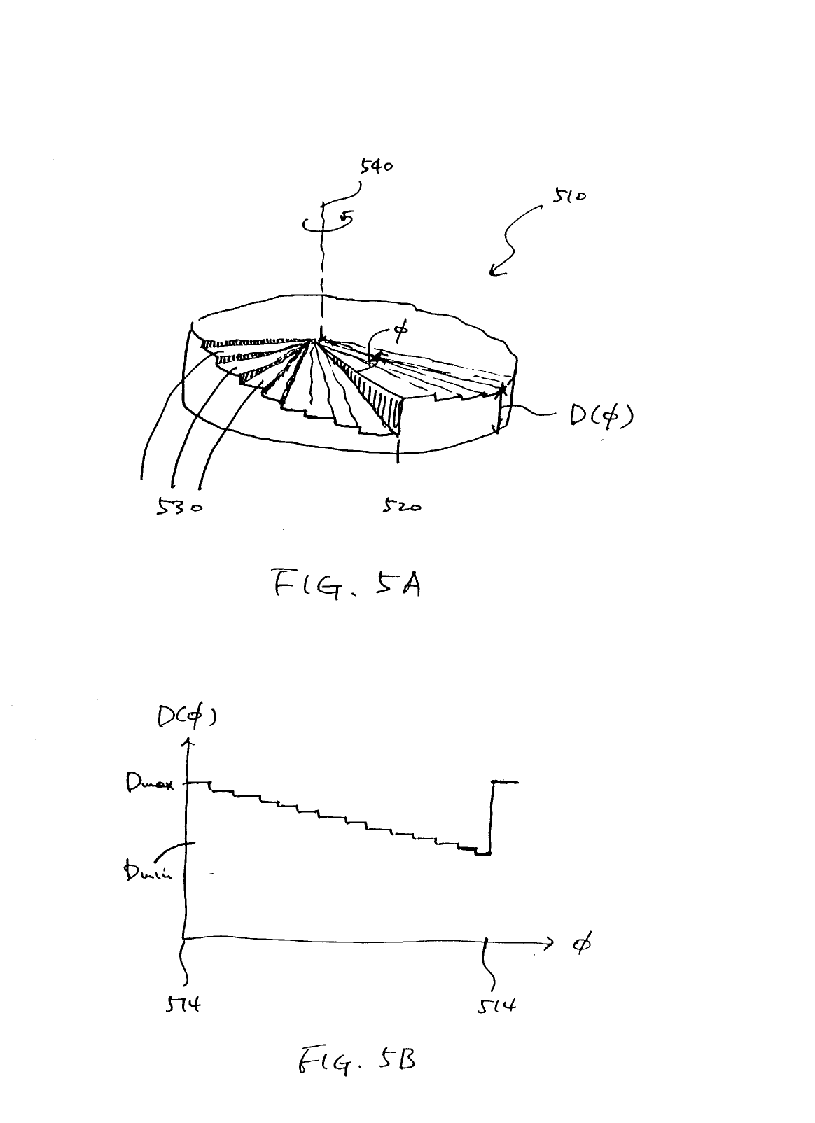

FIG. 5A shows another embodiment of an object distance modifier in accordance with the present invention. In FIG. 5A, the object distance modifier is a disk 510 that includes multiple sectors 530, each having substantially parallel surfaces of different cross sectional thickness (i.e., the thickness has a “stair-step” profile as a function of azimuthal angle φ as shown in FIG. 5B). These sectors provide for a series of discrete image distances rather than a continuously changing image distance provided by the embodiment of FIG. 4A.

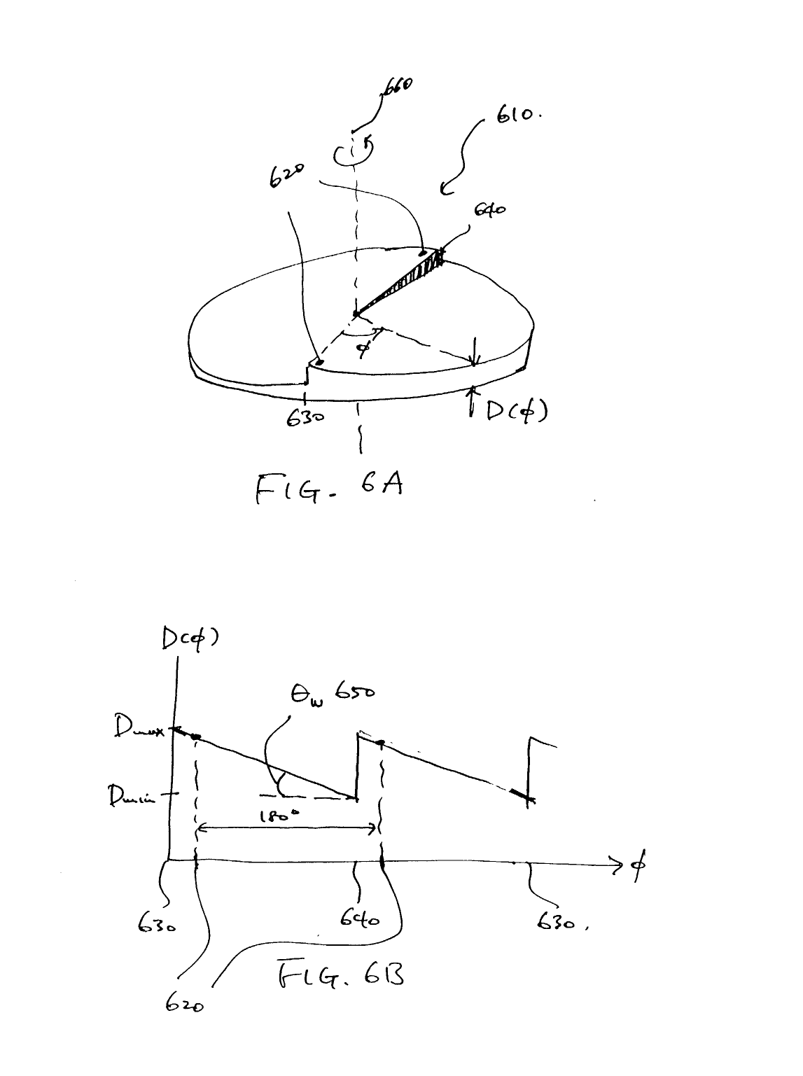

In the embodiments of FIGS. 4 and 5, the thickness profile of the disks varies in a cyclical manner over an azimuthal angle range of 360° However, the thickness profile may be arranged to vary over different ranges of azimuthal angles in a repeating manner. For example, in yet another embodiment of the present invention, sectors of identical thickness may be provided at diametrically opposing sections of the object distance modifier. For example, in FIG. 6A, there are two identical zones of continuously varying thickness within a 180° range of azimuthal angle and situated at opposing sections of the object distance modifier 610. In this embodiment, there are always two points 620 (diametrically opposite to each other) that possess the same thickness. Because the amount of rotation required to reach a particular thickness is reduced by two, the time required to rotate to a region of thickness on the object distance modifier 610 and to effect a corresponding change in the image distance will be similarly reduced. Alternatively, the acquisition time may be kept the same by reducing the rotational speed, the acquisition time being the time it takes for an object distance modifier to rotate such that a desired thickness thereof falls within the optical path of object rays 390. Reducing rotational speed has the advantage of reducing vibration in the system. Moreover, because the object distance modifier 610 is diametrically symmetric in thickness, the object distance modifier 610 is more rotationally balanced, further reducing vibration due to rotation.

In yet another embodiment (not shown), the object distance modifier may have more than two sectors of identical thickness profile. This may allow either further decrease in response time or further decrease in rotational speed.

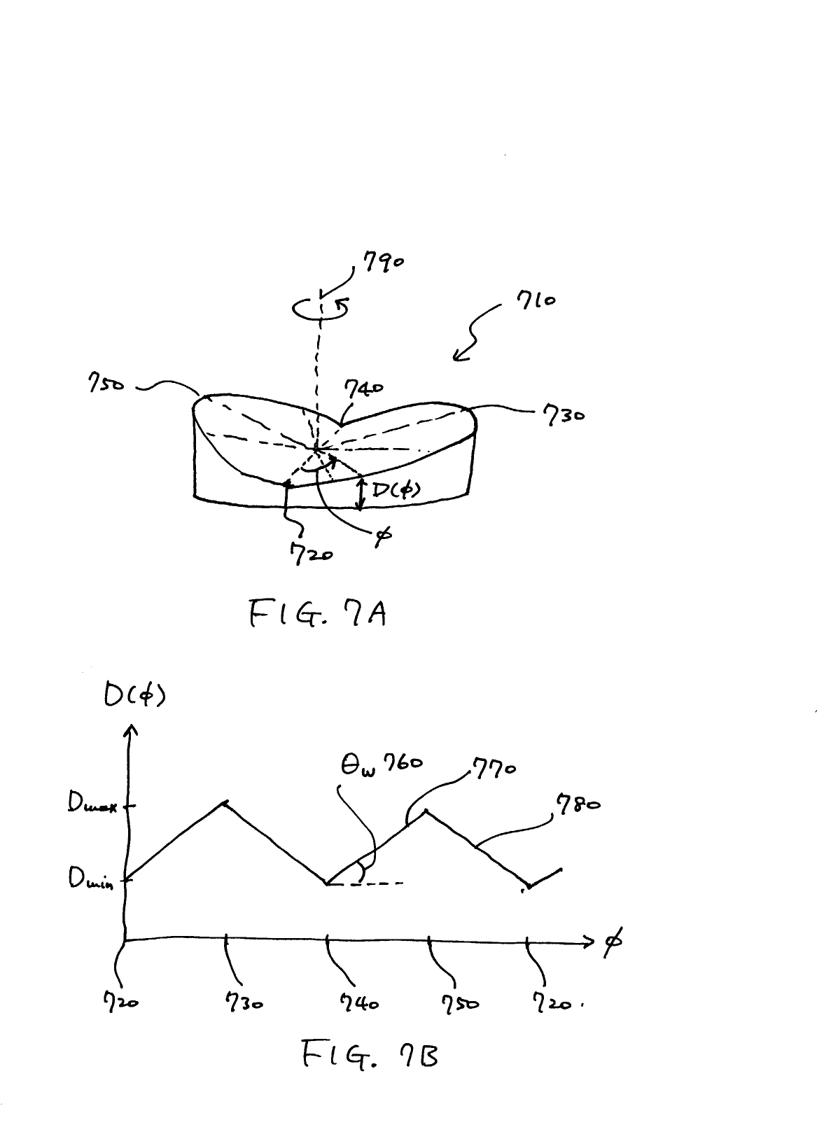

In other embodiments of the present invention, the object distance modifier may have a continuously varying thickness profile without any discrete jump or step-like changes in thickness. FIG. 7A shows an example of an object distance modifier 710 with a “triangular” thickness profile (as shown in FIG. 7B as a function of azimuthal angle φ). As the “triangular” object distance modifier 710 is rotated such that a greater thickness thereof intercepts the optical path of object rays 390, the image distance gradually increases until the maximum is reached, which corresponds to the maximum thickness 730, 750 of the object distance modifier. Further rotation in the same direction will reduce the image distance until the minimum image distance is reached at minimum thickness 720, 740 of the object distance modifier. The use of an object distance modifier with a “triangular” thickness profile avoids the abrupt discontinuity associated with the “saw-tooth” or “stair-step” thickness profiles of FIGS. 4B, 5B and 6B, thereby making fabrication easier. In yet another embodiment of the present invention (not shown), an object distance modifier may have a “sinusoidal” thickness profile.

When the object distance modifier 710 having the triangular thickness profile shown in FIGS. 7A and 7B is used in a multi-planar volumetric display system, the planes 340 of the multiple optical element 32 are updated at an irregular frequency. A similar problem would exist if an object distance modifier having a sinusoidal thickness profile were to be used. For example, in the case of object distance modifier 710 having a triangular profile, let us consider an MOE 32 being refreshed at 50 Hz with a corresponding refresh period of 20 milliseconds. In a 20-plane MOE device, this corresponds to 1 msec per plane. If we refresh plane 1 at 0 msec then plane 2 is refreshed at 1 msec and so on until plane 19 is refreshed at 18 msec and plane 20 is refreshed at 19 msec. Plane 20 is then immediately refreshed again at 20 msec and plane 19 at 21 msec. Consequently, the planes near the center of MOE are refreshed close to every 20 msec while planes near plane 1 or plane 20 are refreshed twice with a short time interval and then not again for 40 msec. This variable refresh rate through the MOE device may produce troublesome flicker characteristics.

This problem can be solved by the use of multi-planar interlacing. Multi-planar interlacing is performed by projecting images onto the even numbered planes as the plane number is increasing and projecting images onto odd numbered planes as the plane number is decreasing, or vice versa. As a consequence, each plane is updated at substantially the same rate. However, in this situation, it is necessary to double the rotational frequency of the object distance modifier 710 so that the modifier reaches its thinnest or thickest point at the end of each refresh cycle.

In the embodiments shown in FIGS. 4A and 6A, continuous rotation of the object distance modifier at a constant rate will result in the image distance varying as in a “saw-tooth” waveform. In the embodiment shown in FIG. 5A, continuous rotation of the object distance modifier will result in the image distance varying as in a “stair-step” waveform. These types of image distance variations may be very useful, for example, in a multi-planar volumetric display system in which a high speed video projector projects two-dimensional slices of a three-dimensional image onto a respective plurality of optical elements (such as in a multiple optical element device 32 of FIG. 1). Careful control of the speed of the motor allows the variation of the image distance to be synchronized with the high speed video projector so that the resultant three-dimensional image remains focused at all depths within the volumetric display system.

On the other hand, the presence of discrete jumps and step-like changes in thickness in the embodiments shown in FIGS. 4A, 5A and 6A may cause image aberrations, when these discontinuous jumps in thickness of the object distance modifier cross the optical path between the object and lens. In that case, the use of the object distance modifier with a continuous thickness profile (such as one with a “triangular” profile in FIG. 7A or “sinusoidal” profile) may be preferred.

It is possible to compute the wedge angle of the object distance modifier as a function of its diameter, thickness range, and number of repeated segments. FIGS. 4B, 6B and 7B illustrate wedge angles θ_{W} 450, 650 and 760, respectively. For example, an object distance modifier formed as shown in FIG. 6A with a 180 mm diameter, thickness variation of 1 mm and two repeated segments, each of 180 degrees, has a wedge angle of 0.244 degrees. Depending on the precise location of the object distance modifier between the object 300 and the lens 330, this wedge may deflect the projected images. For example, in the case of the object distance modifier 710 with a “triangular” thickness profile as shown in FIG. 7B, there may be a positional shift in the projected images at the same image distance depending upon whether the thickness is increasing along segment 770 or decreasing along segment 780. This shift can, under some circumstances be large enough to misalign the pixels projected during increasing thickness of the modifier with those projected during decreasing thickness of the modifier. In a worse case, if the object distance modifier described above was at the location of the lens and the image distance was 2000 mm, the image would be deflected by as much as 4.25 mm. This kind of deflection could produce a noticeable aberration in the projected image.

Fortunately, this problem can be addressed by employing an object distance modifier having the minimum thickness range necessary to meet the depth of focus requirement. The projection system has an inherent depth of focus capable of producing a resolved image over some fraction of the image distance range without resorting to the use of the present invention. For example, an F/2.5 projection lens arranged to form an image with magnification of 27.6 has a depth of focus of 53.4 mm. If the total image distance to be accommodated covers a range of 100 mm, then the variable focusing projection system only needs to provide additional focusing range of 46.6 mm. Since the relationship between focus depth and thickness range for an object distance modifier is linear, the thickness variation needed to accommodate this range is 0.19 mm and the wedge angle, assuming a disk having the geometry of FIG. 7A, is reduced to 0.046 degrees with a corresponding reduction in image offset.

In a digital video projection system, any remaining image offset can be accommodated digitally by simply shifting the image in one transverse direction during the increasing thickness phase and in the other direction during the decreasing thickness phase. This will allow the images to remain registered throughout the entire refresh period.

A range of techniques may be employed to construct object distance modifiers 320, 410, 510, 610 and 710. Injection molding of plastic offers a simple and reliable approach. However, other forming techniques, such as casting, embossing, pressing, or any other suitable forming technique may also be used. Alternatively, glass may be figured by hand or by automated fabrication equipment including, but not limited to, a magneto-rheological figuring process.

In an alternative embodiment, the object distance modifier may be constructed by forming a layer of transparent material having azimuthally varying thickness over a flat glass disk. Any suitable transparent material, such as plastic, may be used. In this embodiment, a flat glass disk provides strength and rigidity while the additional transparent layer provides the desired profile. The transparent layer may be formed by any of the methods mentioned above or by any other suitable method. In yet another embodiment, the transparent layer may be applied by rotating a glass disk into and then out of a bath of photo-curable optical cement such as Norland NOA88. A radially oriented line of ultraviolet light may be used to cure the cement. The time between an area of the disk leaving the uncured cement and the cement's curing determines the final thickness of the layer. Computer control of the rotation rate at each azimuthal angle can then be used to produce any desired thickness profile.

Now that the preferred embodiments of the present invention have been shown and described in detail, various modifications and improvements thereon will become readily apparent to those skilled in the art. Accordingly, the spirit and scope of the present invention is to be construed broadly and limited only by the appended claims, and not by the foregoing specification.

We claim:

1. An image projector for projecting and focusing a plurality of image slices generated by an image source onto a corresponding plurality of optical elements located at different distances from said image projector to generate a volumetric three-dimensional image, comprising:
a projection lens;
an object distance modifier having an index of refraction greater than 1 and variable thickness; and
means for controllably positioning a predetermined thickness of said object distance modifier in the optical path between said image source and said projection lens to focus each of said image slices onto its corresponding optical element.

2. The image projector of claim 1, wherein:
said object distance modifier comprises a disk having an azimuthally varying thickness; and
said means for controllably positioning said predetermined thickness comprises a rotation device for rotating said disk around a rotational axis.

3. The image projector of claim 2, wherein said rotational axis of said disk is parallel to the optical axis of said projection lens.

4. The image projector of claim 2, wherein said azimuthally varying thickness of said disk has a continuously varying profile.

5. The image projector of claim 4, wherein said continuously varying profile of said disk is substantially sinusoidal.

6. The image projector of claim 4, wherein said continuously varying profile of said disk is substantially triangular.

7. The image projector of claim 2, wherein said azimuthally varying thickness of said disk has a stair-step profile.

8. The image projector of claim 2, wherein said azimuthally varying thickness of said disk has a saw-tooth profile.

9. The image projector of claim 2, wherein said disk is diametrically symmetric in thickness.

10. The image projector of claim 2, wherein said disk has a plurality of sectors, each having an identical thickness variation profile.

11. A system for generating a volumetric three-dimensional image, comprising:
an image source providing a plurality of image slices;
a multiple optical element device including a plurality of optical elements located at different distances from said image source;
an image projector having a projection lens for projecting each of said image slices onto respective ones of said optical elements to generate a volumetric three-dimensional image;
an object distance modifier having an index of refraction greater than 1 and variable thickness; and
means for controllably positioning a predetermined thickness of said object distance modifier along the optical path between said image source and said projection lens to focus each of said image slices onto its corresponding optical element at an image distance determined by said predetermined thickness and said index of refraction.

12. The system of claim 11, wherein:
said object distance modifier comprises a disk having an azimuthally varying thickness; and
said means for controllably positioning said predetermined thickness comprises a rotation device for rotating said disk around a rotational axis.

13. The system of claim 12, wherein said rotational axis of said disk is parallel to the optical axis of said projection lens.

14. The system of claim 12, wherein said azimuthally varying thickness of said disk has a continuously varying profile.

15. The system of claim 14, wherein said continuously varying profile of said disk is substantially sinusoidal.

16. The system of claim 14, wherein said continuously varying profile of said disk is substantially triangular.

17. The system of claim 15, wherein said image projector projects and focuses said plurality of image slices onto said optical elements in an interlaced manner so as to refresh all of said optical elements at a substantially constant rate.

18. The system of claim 16, wherein said image projector projects and focuses said plurality of image slices onto said optical elements in an interlaced manner so as to refresh all of said optical elements at a substantially constant rate.

19. The system of claim 12, wherein said azimuthally varying thickness of said disk has a stair-step profile.

20. The system of claim 12, wherein said azimuthally varying thickness of said disk has a saw-tooth profile.

21. The system of claim 12, wherein said disk is diametrically symmetric in thickness.

22. The system of claim 12, wherein said disk has a plurality of sectors, each having an identical thickness variation profile.

23. A method for projecting and focusing through a projection lens a plurality of image slices generated by an image source onto a corresponding plurality of optical elements located at different distances from said projection lens to generate a volumetric three-dimensional image, comprising the steps of:
providing an object distance modifier having an index of refraction greater than 1 and variable thickness between said image source and said projection lens; and
positioning a predetermined thickness of said object distance modifier along the optical path to focus each of said image slices onto its corresponding optical element.

24. The method of claim 23, wherein:
said object distance modifier comprises a disk having an azimuthally varying thickness; and
said step of positioning a predetermined thickness of said object distance modifier includes the step of rotating said disk around a rotational axis to position said predetermined thickness in said optical path.

25. A method for generating a volumetric three-dimensional image, comprising the steps of:
providing an image source for generating a plurality of two-dimensional image slices of said three-dimensional image;
providing a plurality of optical elements at different image distances, each of said optical elements receiving a corresponding one of said image slices;
providing an object distance modifier having an index of refraction greater than 1 and variable thickness in the optical path between said image source and a projection lens; and
positioning a predetermined thickness of said object distance modifier along said optical path to focus each of said two-dimensional image slices at an image distance determined by said predetermined thickness and said index of refraction;
whereby each of said image slices is focused onto its corresponding optical element.

26. The method of claim 25, wherein:
said object distance modifier comprises a disk having an azimuthally varying thickness; and
said step of positioning a predetermined thickness of said object distance modifier includes the step of rotating said disk around a rotational axis to position said predetermined thickness in said optical path.
